(19) United States
(12) Patent Application Publication
(10) Pub. No.: US 2006/0004499 A1
(43) Pub. Date: Jan. 5, 2006

(54) Structural health management architecture using sensor technology

(76) Inventors: Angela Trego, Richland, WA (US); Eric D. Haugse, Seattle, WA (US); Robert L. Avery, Bellevue, WA (US); Aydin Akdeniz, Redmond, WA (US); Cori Greenberg, Kirkland, WA (US); David M. Anderson, Issaquah, WA (US); Richard J. Reuter, Seattle, WA (US)

Correspondence Address: Robert Villhard;Thompson Coburn LLP, One US Bank Plaza, St. Louis, MO, 63101, US

(21) Appl. No.: 10/880,659

(22) Filed: Jun. 30, 2004

(51) Int. Cl. G06F 17/00

(52) U.S. Cl. 701/29; 701/3

(57) ABSTRACT

A mobile platform comprising at least one mobile platform system that includes a processor, a structure, and an SHM system. The SHM system also includes a processor as well as a structural sensor. The SHM processor is separate from the mobile platform system processor. In other preferred embodiments, the mobile platform includes a flight control system, a maintenance information system, and an IVHM system. The SHM system may receive parameters from the flight control system and calculate loads therefrom. Alternatively, the sensor may be a structural load sensor, which the SHM processor uses along with the parameters, to calculate other structural loads. In still another preferred embodiment, a method is provided that includes separating SHM functions from a processor of a mobile platform system. The method also includes dedicating an SHM system to perform SHM functions and establishing communications between the SHM system and the mobile platform system.

### FIELD OF THE INVENTION

This invention relates generally to structural health management and, more particularly, to systems, architectures, and methods for managing the structural health of mobile platforms such as aircraft.

### BACKGROUND OF THE INVENTION

Maintenance costs have become a key component of the life cycle costs associated with commercial and military aircraft. Further, most of the expense of maintaining a metallic aluminum aircraft is associated with corrosion prevention and control. For a typical fleet of aircraft, 70% of all structural maintenance expense is incurred inspecting the airframes during periodic (frequency-based) maintenance tasks. More particularly, the majority of the inspection expenses are associated with accessing hidden portions of the airframe. The remaining 30% of the maintenance expenses are incurred actually repairing fatigue cracks and other structural damage found during the inspections. To put these expenses in perspective, more than twice the amount spent fixing damage is spent accessing the area, and performing the inspections for finding the damage. Thus, overall maintenance costs can be reduced by replacing periodic (frequency-based) inspections with a combination of automated detection of structural damage, degradation, (and the occurrence of events that might cause the same), and maintenance based on these conditions (i.e. condition based maintenance).

The use of increasing amounts of non-traditional materials (e.g. composites) is changing the types of maintenance information desired for monitoring the health of the overall structure. For instance, less information regarding metallic corrosion will be desired while other additional types of information will be desired to ascertain the health of the composite members. Thus, the changes in the mix of desired information necessitate modifying the integrated vehicle health management (IVHM) system by adding various sensors, in particular, for monitoring the composites. These additional sensors include, but are not limited to, high bandwidth structural sensors, corrosion sensors, load, and inertial sensors.

IVHM systems allow mobile platform operators to gather, record, and analyze information describing the operational status of the active components (including electronic components that are functionally active in that they produce observable outputs—signals) of their mobile platforms. For instance, modern turbojets are instrumented with sensors to monitor the engine and to detect incipient failures thereof. Upon detection of an incipient failure, the operator can correct the incipient failure in time to avoid schedule interruptions. Before the advent of IVHM, however, the operator would have periodically removed the engine from service for extensive inspections and preventative maintenance even in the absence of a condition warranting engine removal. Whether the inspections revealed damage or degradation of the structure, the frequency-based inspection approach requires the operator to incur costs by inspecting the engine. Also, the frequency-based inspection approach forces the operator to incur opportunity costs by removing the engine from service. After implementing IVHM on the engine, though, the operator now typically waits until the IVHM system detects a condition warranting engine removal prior to removing the engine from service.

One area that IVHM systems do not address is the health of the passive structural members of the mobile platforms. The reasons that IVHM systems have failed to address structural health monitoring (SHM) include the difficulty of handling the large amounts of data and related processing that SHM entails. IVHM sensors are typically sampled at comparatively low frequencies (i.e. tens to hundreds of hertz or lower), whereas SHM sensors often require rapid sampling rates (i.e. hundreds to thousands of hertz or higher) to yield useful information. Further, an IVHM system typically monitors several hundred, to perhaps a thousand sensors, whereas an effective SHM system might have tens of thousands of structural members within its purview. Given the number of structural members and the high data rates associated with structural sensors, a completely instrumented, conventional, SHM system would overwhelm the throughput provided by today's flight-qualified processors and networks. Moreover, as with any mobile platform system, IVHM systems are constrained by the desire to conserve cost, weight, power, and space. Thus, increasing the size of the IVHM is not desirable.

Therefore, a need exists to provide a practical SHM system for mobile platforms.

### SUMMARY OF THE INVENTION

It is in view of the above problems that the present invention was developed. The invention provides improved SHM systems, architectures, networks, and methods.

To address the need for structural health monitoring, the present invention provides autonomous SHM systems, architectures, networks, and methods, thereby enabling condition-based maintenance of the aircraft structure. Thus, the present invention assists maintenance personnel in their efforts to identify structural degradation and damage. Also, the present invention decreases the amount of frequency-based maintenance required for mobile platform structures.

In a first preferred embodiment, the present invention provides a mobile platform comprising at least one mobile platform system that includes a processor. The mobile platform also includes a structure and an SHM system. The SHM system includes another processor and a structural sensor. The dedicated SHM processor is separate from the mobile platform system processor. In another specific embodiment, the SHM system may also process existing mobile platform parameters to determine structural loading conditions. In particular, the airplane parameters may be correlated with mobile platform loads via structural load models so that, depending on which loads are of interest, insight into the loads can be gained without the addition of structural sensors. In other preferred embodiments, the mobile platform includes flight control, maintenance information, and IVHM systems. In embodiments with a flight control system, the SHM system may receive parameters from the flight control system to determine loads on the structure therefrom. Alternatively, the sensor may be a structural load sensor, which the SHM processor uses, along with the parameters, to determine still other loads. In yet another preferred embodiment, the present invention provides a method that includes separating SHM functions from a pre-existing processor of a mobile platform system. The method also includes dedicating an SHM system to perform SHM functions and establishing communications between the SHM system and the mobile platform system.

In a preferred embodiment the SHM system will monitor multiple areas of the aircraft structure to minimize maintenance by reducing or eliminating routine inspections and by assisting in the evaluation and assessment of non-destructive inspection for incidental damage or specific mandated inspections by regulatory agencies. Ideally a low-cost low weight system will allow 100% monitoring for all types of damage. However, initially high SHM systems costs (sensors costs, SHM processor, software & network costs, SHM installation costs, and maintenance costs) will not be practical for implementation. Therefore, in a preferred embodiment, the SHM system will support monitoring in areas that have high return with low cost risk, such as areas that are difficult to access for inspection or have a high cost impact due to frequent inspections or other cost factors—such as areas near, on, under or behind, the aircraft lavatories and galleys, floor beams, door surrounds, pressure bulkheads, fuselage and wing hard landing inspection areas, vertical stabilizer attachment, pylon to wing attachment and strut, fuselage crown structure, fuselage structure under wing to body fairing, wing ribs, cockpit window sills, wing center section, fuselage structure above the wing center section and main landing gear bay, and fuselage structure in the bilge area. In the preferred embodiment the SHM system sensors in sparse (or dense) arrays can also be used to support annoyance maintenance, non-safety issues, such as for locating acoustic vibrations. Another preferred embodiment also includes provisions for adding additional monitoring equipment throughout the airplane's service life.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates an aircraft constructed in accordance with a preferred embodiment of the present invention;

FIG. 2 illustrates a data system architecture of the aircraft of FIG. 1; and

FIG. 3 illustrates a structural health monitoring architecture of the aircraft of FIG. 1.

### DETAILED DESCRIPTION OF THE PREFERRED EMBODIMENTS

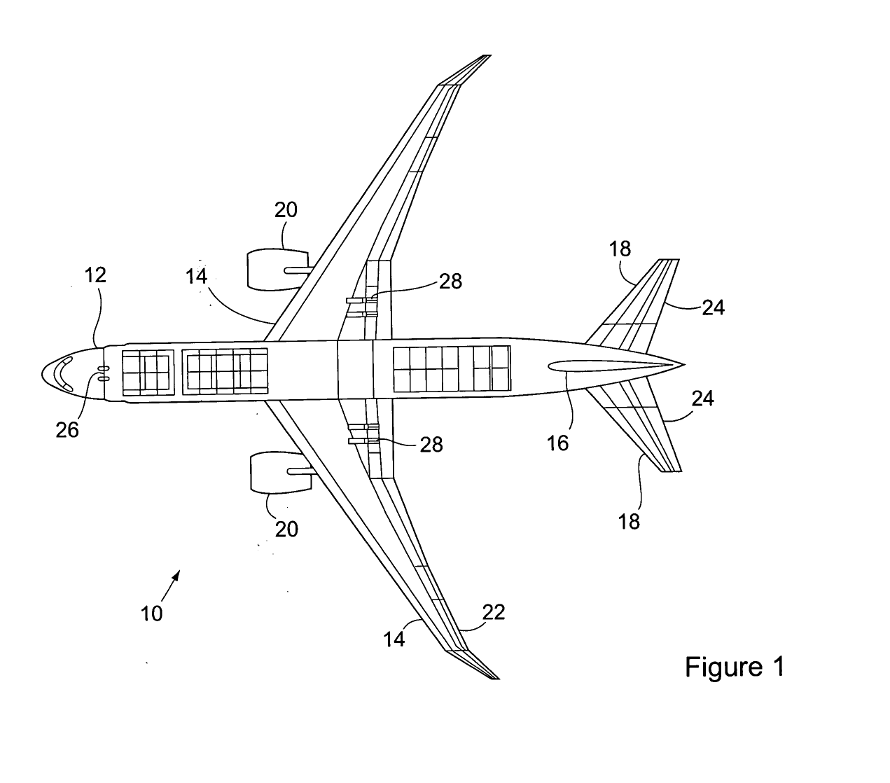

Referring to the accompanying drawings in which like reference numbers indicate like elements, FIG. 1 illustrates a plan view of a mobile platform constructed in accordance with the principals of the present invention. The exemplary mobile platform illustrated is a commercial transport aircraft 10 that generally includes active components and passive structural elements. Though, the mobile platform 10 could be any type of mobile platform such as an aircraft, a spacecraft, or ground or marine vehicles. An IVHM system on the aircraft 10 monitors the health of the active components, whereas a dedicated SHM system (to be described in more detail herein) monitors the health of the structural elements. The monitored structural elements include a fuselage 12, a pair of wings 14, a vertical stabilizer 16, and a pair of horizontal stabilizers 18. These major structural elements 12 to 18 further include many assemblies, sub-assemblies, and individual components that are well known in the art. Generally, the structural elements 12 to 18 remain stationary with respect to each other, although some relative motion is inherent between the elements, for example as evidenced by flexing of the wings. The structural elements serve to distribute constant loads (e.g. the weight of the aircraft 10), dynamic loads (e.g. the thrust from the engines), and transient loads (e.g. shocks, vibrations, and impact induced impulses). Traditionally, the structural elements 12 to 18 are formed from various metals, particularly aluminum. Increasingly, though, the elements 12 to 18 are formed from composite materials, which behave in a more complex manner than traditional materials when subjected to a load. That is, when a traditional material might exhibit a strain, or yield, a composite material might also, for example, delaminate. Because increased insight into the health of the structure decreases inspection costs, aircraft operators can reduce overall maintenance costs by maintaining, or increasing, the amount of monitoring of airframe structures 12 to 18 and the sub-assemblies thereof.

As shown in FIG. 1, the aircraft 10 also includes many active components that impart energy to the aircraft 10, or move relative to the aircraft 10, or to perform a variety of other functions. Typical active components, or assemblies, include a pair of engines 20, ailerons 22, elevators 24, and nose and wing landing gear mechanisms 26 and 28 respectively. Traditionally, the comparatively lower data rates and numbers of sensors required to adequately monitor the active components 20 to 28 (and sub-assemblies thereof) have allowed the conventional data systems onboard the aircraft 10 to perform IVHM for the active portions of the aircraft 10.

By contrast, the structural members 12 to 18 comprise thousands of individual members (e.g. load carrying body panels, trusses, stringers, ribs, and the like). While many SHM sensors (e.g. strain sensors) operate at the comparatively lower sampling rates akin to the IVHM sensors, many other SHM sensors operate at much higher frequencies. For instance, shock, vibration, and ultrasonic non-destructive inspection sensors must be sampled rapidly to provide adequate insight into the phenomenon that they are intended to monitor. In contrast, corrosion sensors may be sampled infrequently (e.g. every minute, weekly, or monthly) yet still provide adequate insight into the health of the structure when analyzed on a less frequent basis (e.g. annually). Taken as a group, therefore, the SHM sensors generate a large volume (i.e. high bandwidth) of data for which existing aircraft data systems cannot economically, or practically, be configured to accommodate.

Currently, scheduled inspections of the aircraft 10 structures are driven primarily by a given element's susceptibility to environmental considerations, although fatigue and susceptibility to accidental damage also play roles in the frequency of inspection. The present invention provides systems, architectures, networks, and methods to reduce the requirement for these periodic inspections. Also, the present invention provides strategically placed sensors and an autonomous SHM system to detect events and conditions that warrant unscheduled inspections. More particularly, sensors are included at difficult to access locations to reduce the need to inspect these areas. Thus, the present invention eliminates the time and labor required to access and inspect these inaccessible areas. Also, the time and labor necessary to repair damage to the aircraft, incidental to the access effort, is likewise eliminated. Further, because many of these areas are typically sealed (or otherwise protected from the environment) at the factory, the superior factory protection seal is maintained until a condition warranting intrusion is sensed.

In contrast to the scheduled inspections discussed above, unscheduled inspections are currently driven primarily by a structural member's susceptibility to accidental damage. Thus, the present invention also provides systems, architectures, networks and methods useful for detecting and assessing accidental damage. The present invention also reduces the occurrence of unscheduled inspections to only those inspections necessary to respond to actual damage and degradation. “Hard landings” represent an example of events that might cause such accidental damage. These hard landings currently require time-consuming, invasive, unscheduled inspections of the landing gear and other structures exposed to hard landings induced forces. Yet, on average, 98 to 99% of hard-landing inspections reveal no damage. Thus, in accordance with the principles of the present invention, it is desirable to conduct only a sufficient number of unscheduled inspections to reveal the results of the 1 to 2% of hard landings for which the SHM system indicates the desirability of inspecting an affected area. Because of these advantages, the present invention reduces aircraft down time and maintenance expenses.

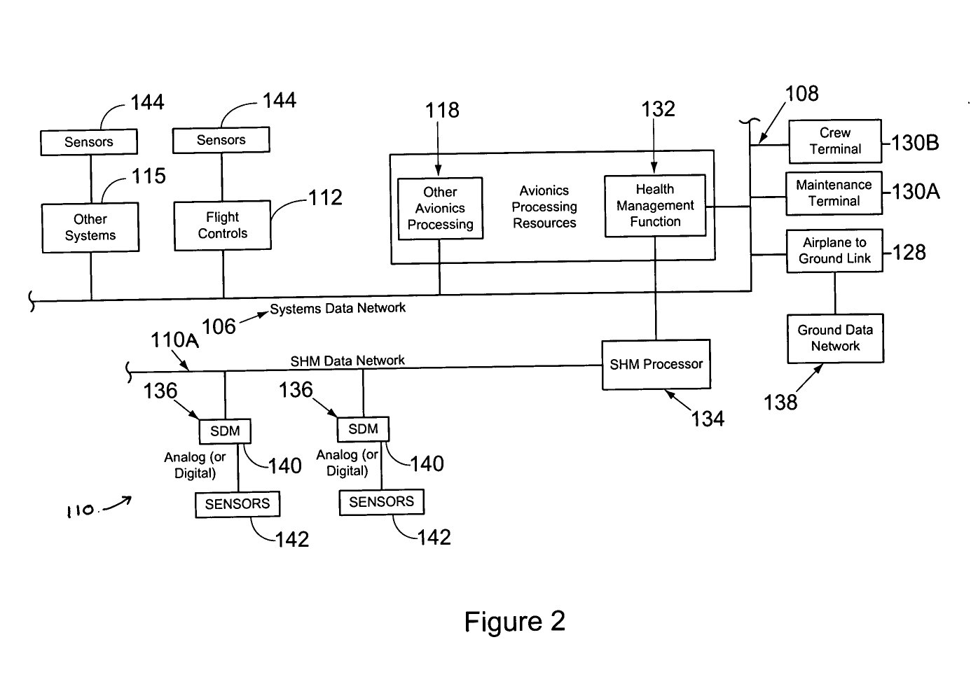

With reference now to FIG. 2, an aircraft-level view of a preferred embodiment of the present invention is illustrated. The overall aircraft system 100 shown includes systems 106, 108, and 110 communicating as shown via networks provided with, or by, the systems. Further details of the systems and networks shown can be found in subsequent portions of the description herein provided. More particularly, the systems data network 106 is shown communicating with health management, avionics, flight controls, and other functions. Though, in some aircraft, the various systems may communicate directly with each other rather than via an intermediary such as the data systems network 106. The dedicated SHM network 110A also communicates with the maintenance information system 108. The maintenance information system 108 includes an aircraft-to-ground link 128, a maintenance crew station 130A, a flight crew station 130B, and preferably an IVHM function 132. In the alternative, the IVHM application (or function) can be part of the pre-existing overall data network 106. The aircraft-to-ground link 128 communicates SHM data and information between the SHM processor 134 and the ground SHM system 138. In the alternative, the SHM system 110 may communicate with the ground SHM system 138 in parallel with the IVHM application 132. Maintenance personnel can therefore access the structural maintenance related information (including the SHM data and information) via the maintenance crew station 130A (located on board the aircraft in an area easily accessible to the ground based maintenance crews), as can the flight crew via flight crew station 130B (typically on the flight deck).

The “systems” discussed herein with typically include combinations of software applications, firmware, neural networks, algorithms, networks, processors, sensors, data concentrators, signal conditioners, and other hardware as will be further described. Further, those skilled in the art will recognize that the functions performed by the systems may be distributed in various manners depending on the specific application of the invention involved. Thus, phrases such as “the system performs a function” will be recognized to mean that some, or all, of the system may be involved in performing the function. For instance, because a system can include a “network,” a system can communicate with other systems via the system's network. Of course, a network typically consists of various nodes (or points), the communications paths there between, and the related software. For clarity, therefore, when the primary function involved in a particular discussion of a system includes communications, the term “network” will usually be used to designate the portion of the “system” performing the function. Therefore, because the optional systems data system 106 primarily provides communications between systems, the systems data system 106 will usually be referred to as a network. Moreover, since the other systems discussed (e.g. the SHM system 110) typically perform functions in addition to communications, these other systems will usually be referred to as systems instead of networks.

Turning now to the SHM system 110, the dedicated SHM system 110 includes a dedicated SHM processor 134, structural data modules or concentrators 136 (e.g. multiplexer/demultiplexers), as many SHM sensors 142 as the operator desires for monitoring the aircraft structure, and a dedicated network 110A allowing communications there between. The data modules 136 communicate with the sensors 142 to signal condition, gather, record, pre-process, and process the sensor data in accordance with the distribution of functions selected for a given application. The SHM processor 134 receives the sensor data from the data module 136 and manipulates it to ascertain the health of the monitored structures. The SHM processor 134 may also receive data from sensors 144 in other systems 115 (including the flight controls system 112) via the overall system data network 106. Further, to allow the SHM system 110 to be independent of the aircraft power system, a battery may power the SHM system 110 hardware, or some portion thereof. Of course, the SHM system 110 may also draw power from the onboard power system.

The SHM system may also rely on the other systems 115 in other ways. One way the SHM system can rely on these other systems 115 is the SHM system 110 may receive data (or information) pertaining to the conditions sensed by the sensors 144 associated with the other systems 115. Avionic unit and hydraulic line temperatures are specific examples of the sensors 144 that the SHM system 110 may receive data and SHM related information from. Additionally, it may sometimes occur that an SHM sensor 142 may be located in an area of the aircraft remote from the SHM system 110 or any portion thereof. In such situations, it may be impractical to connect the SHM sensor 142 directly to the SHM system 110. Thus, the SHM sensor 142 may be connected to one of the other systems 115 that, in turn, communicates data and information from the sensor 142 to the SHM system 110. Moreover, it may sometimes be preferable to duplicate a sensor 144 of one of the other systems 115 with a separate sensor 142 dedicated to the SHM system 110. For instance, the SHM system 110 may include an aircraft pitch rate sensor 142 rather than relying on the flight control system 112 for such data or information.

Moreover, FIG. 2 shows a ground based SHM data system 138 communicating with the airborne SHM system 110 to allow for downloading SHM data to a fleet database and for uploading SHM related data, software, and other information or files to the airborne portion of the SHM system 110. In other preferred embodiments, much of the SHM system 110 is positioned off of the aircraft during nominal flight and connected to the remainder of the SHM system 110 when desired. For instance, the SHM processor 134 and some of the sensors and the data modules 136 can be ground based with suitable connections made to monitor the sensors 142 when the aircraft is on the ground. In these embodiments, much of the weight, power, and space otherwise required for the SHM system 110 can be utilized elsewhere during nominal flight.

The overall SHM system associated with a fleet of aircraft includes the ground SHM system 138 and each of the SHM systems 110 associated with the fleet of individual aircraft. Thus, the overall SHM system includes the ground SHM system 138 (preferably common to all aircraft in the fleet), and the crew and maintenance terminals 130A and 130B, the SHM processor 134, the structural data modules 136, the sensors 142, and the other portions of the SHM system 110 associated with each of the aircraft.

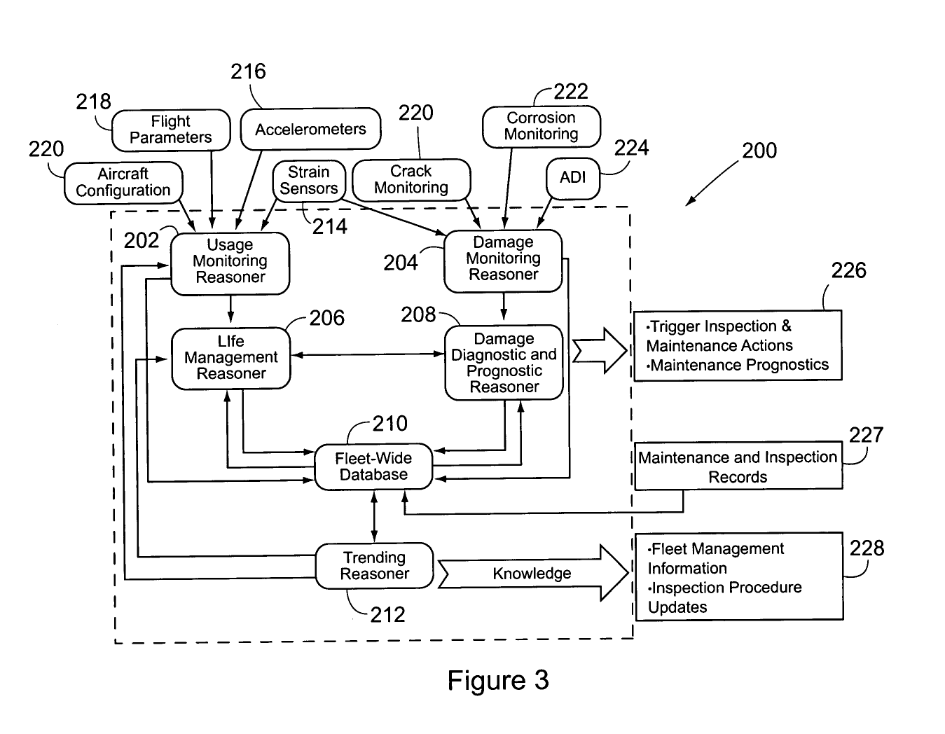

FIG. 3 shows an exemplary embodiment of the SHM software resident on the SHM network 110 along with several exemplary inputs and outputs of the SHM software. Of course, the functions illustrated by FIG. 3 may be distributed to optimize the amount of data and network traffic generated by the system. The SHM application is shown schematically at reference 200 and includes a usage-monitoring reasoner 202, a damage-monitoring reasoner 204, a life management reasoner 206, a damage diagnostic and prognostic reasoner 208, a fleet-wide database 210, and a trending reasoner 212 as shown. Generally, the usage reasoner 202 attends to monitoring and assessing those conditions of the structure associated with the load environment experienced by the structure. Thus, the usage reasoner 202 communicates with, for example, strain sensors 214 and accelerometers 216 to gather real-time data regarding the loads on the structure including compressive, tensile, sheer, vibration, impact, and shock loads. Also, the usage reasoner 202 communicates with the systems data network 106 (see FIG. 2) to receive real-time flight parameters 218. These flight parameters 218 include, but are not limited to, rigid body accelerations, inertial measurements, air speed, temperatures, pressures, and control surface and landing gear positions. From the monitored data, the usage monitor 202 develops information regarding the current loads on, and the load history of, the structure. For instance, the usage monitor may include a fatigue assessment model of the structure, which it uses to evaluate the structure in light of the fatigue it has experienced.

In a preferred embodiment, the usage monitor 202 includes an intelligent load monitoring algorithm, a neural network, or a lookup table derived from the results of an algorithm or neural network used to develop the usage monitor. The algorithm, neural network, or lookup table monitors strain sensors, accelerometers, and various flight parameters (that might include, but are not limited to, sink rate, roll rate, pitch, pitch rate, airspeed, control surface positions, fuel weight and distribution, stores, and cargo configurations) and transforms the data into information regarding the loads experienced by structural members throughout the aircraft. If the usage monitor 202 includes a neural network, the neural network is trained to determine the loads experienced by structural members that are not instrumented from more directly sensed loads experienced by instrumented structures. Thus, the intelligent load monitor (of the usage monitor 202) enables a reduction in the number of load sensors required to monitor the health of the aircraft structure.

In contrast to the usage reasoner 202 of FIG. 3, the damage reasoner 204 generally attends to monitoring and assessing those conditions associated with structurally damaging or degrading events and conditions. Thus, the damage reasoner 204 communicates with crack monitors 220 (e.g. passive acoustic sensors, active acoustic sensors, and ultrasonic sensors), corrosion sensors 222 (e.g. moisture, relative humidity, affinity, and corrosion byproduct sensors), and active damage interrogators 224 (e.g. active acoustic sensors). From the monitored data, the damage reasoner 204 develops information regarding likely, incipient, and actual damage and degradation of the structure. In particular, the damage reasoner 204 senses the extent of damage and compares it to allowable damage limits to identify damage (and degradation) for which corrective action is desired. Non-limiting examples of areas exposed to impact include the following doors and surrounding structures: passenger doors, service doors, and cargo doors. Though, these (and other) areas may also experience environmental conditions conducive to corrosion. Accordingly, the usage monitor 202 may include a probabilistic corrosion model to predict the initiation of corrosion and assess the subsequent progress thereof.

Using the information developed by the damage reasoner 204 (and the usage reasoner 202), the damage diagnostic and prognostic reasoner 208 triggers inspection and maintenance actions. The damage reasoner 208 also generates reports regarding the prognosis for repairing the damage and degradation detected by the damage reasoner 204. Importantly, because the current invention provides for detection of incipient damage, the inspection and assessment of the structure occurs earlier than would otherwise be the case. As a result, most resulting repairs will be relatively minor compared to than the repairs that would be called for by current practice. Another advantage provided by the present invention arises because much SHM related data may be collected while the aircraft is on the ground. For instance, the crack sensors 220, the corrosion sensors 222, and the active damage interrogators 224 may be interrogated only by the ground-based SHM data-network 138, thereby relieving the flight portion of the SHM system 110 of the associated data throughput and processing otherwise required on the aircraft.

In still another preferred embodiment of the damage reasoner 204, an impact detection algorithm, neural network, or lookup table (derived from the results produced by an algorithm or neural network used to develop the damage reasoner 204) is included in the damage reasoner 204. Strain sensors 214 in communication with the damage reasoner 204 are placed on, and around, structures likely to be subject to impact damage. Exemplary structures exposed to impact include the fuselage 12 (of FIG. 1) near the cargo doors and the galley. When an impact occurs, strain waves propagate through the structure from the point of impact. By detecting the time the strain wave arrives at each of the affected strain sensors 214 of FIG. 3, it is possible for the damage reasoner 204 to determine where the impact occurred in a manner similar to locating the epicenter of an earthquake with seismometer data. But because many aircraft structures include complex, non-isotropic, non-homogenous (e.g. composite) members, exact knowledge of the speed of the wave is difficult to determine. Thus, a neural network might be advantageously employed to locate impacts. This neural network (as well as the other neural networks provided by the present invention) may be trained by allowing it to monitor a representative aircraft structure and providing it the known locations of impacts to which it is exposed. In the alternative, the neural networks may be trained during test flights of new (or pre-existing) aircraft. In another preferred embodiment, the neural networks are trained on structures that include structural repairs so that they learn to identify repairs and learn how to assess damage and degradation of the repairs.

Corrosion sensors 222 may also be located in inaccessible areas of the aircraft to detect incipient corrosion therein. For example, the corrosion sensors 222 of FIG. 3 may be located under the galley floor or within the factory sealed volume enclosing the lavatory sub-assembly or in any aircraft area that is deemed to be hard to access (for example because access requires the removal of components or structural members) or that may benefit from corrosion monitoring. Because the corrosion sensors 222 can provide insight into the health of the inaccessible structures, regular human inspections (and the extensive costs associated with gaining access for the same) is reduced or eliminated. In particular, if corrosion sensors 222 are placed in locations exposed to corrosion favoring conditions, the insight into the health of the structure can be improved.

FIG. 3 also illustrates the life management reasoner 206 receiving information from the usage reasoner 202 regarding current and historical loads on the structure. The life reasoner 206 also receives information from the damage reasoners 204 and 208 regarding damage and degradation to the structure. From the received information, the life management reasoner 206 develops information regarding the service life used, and remaining, for the structure. Similarly, the diagnostic and prognostic reasoner 208 receives information from the other reasoners 202, 204, and 206 and develops information regarding the diagnosis of the damage and degradation of the structure. The damage prognostic reasoner 208 also develops information regarding the prognosis for repairing the damage and degradation detected by the damage-monitoring reasoner 204.

The fleet-wide database 210 illustrated in FIG. 3 communicates with the life management reasoner 206 and the damage diagnostic and prognostic reasoner 208 to gather and store SHM information regarding a particular aircraft. The fleet-wide database 210 is in communication with each aircraft in the fleet via the ground based SHM network 138 (of FIG. 2). From the fleet-wide database 210, the trending reasoner 212 determines SHM related trends affecting the fleet. In a preferred embodiment, the trending reasoner 212 uses data warehousing and mining techniques to identify trends and predict when structural maintenance actions on the various aircraft in the fleet may become desirable. In particular, the trending reasoner 212 identifies fault signatures and correlates the faults with the operational contexts (e.g. a hard landing) in which they occurred. Also, the trending reasoner 212 identifies the signatures of degraded structures from the data and information stored in the fleet-wide database 210. Further, the trending reasoner 212 generates reports 228 indicating improved fleet management and inspection procedures from the identified fault signatures, trends, and other information in the fleet-wide database 210.

In summary, the SHM application 200 of FIG. 3 resides in the dedicated SHM processor 134 of FIG. 2. Other than receiving flight parameters 218 (which the flight control system 112 of FIG. 2 generates for its own internal purposes), receiving other data or information from other systems 115, and sending data to the maintenance information system 108 for display, preferred embodiments of the SHM application 200 do not interact with the other aircraft systems. Preferably, the SHM processor 134 is likewise separate from the other aircraft systems 115. Thus, the SHM application 200 monitors the health of the structure, and develops information regarding the structure, autonomously from the other aircraft systems 106. Moreover, because the SHM system 110 preferably resides in parallel with, and requires no modification of, the other aircraft systems, the SHM system 110 may be added to existing aircraft without requiring recertification of the other aircraft systems. Similarly, because the SHM systems provided by the present invention are not required to control the flight of the aircraft, the SHM system 110 may be un-powered (or otherwise unavailable) even when the other systems 115 are fully operational (e.g. during flight). The SHM system 110, therefore, may be designed to meet a lower system availability threshold than the other onboard systems. Though the SHM system 110 may also meet the availability threshold of the other systems 115.

In another preferred embodiment, the SHM processor 134 communicates with a removable memory device (e.g. an EEPROM, a floppy disk, or any storage device) to store SHM data and information thereon. Upon landing, the gate crew removes the memory device, reads the SHM data and information therefrom, and uses the ground based SHM data network 138 to analyze the SHM data and information collected during the most recent flight. Because no SHM network 110A data access (e.g. connecting an external computer to the SHM network, logging on, and initiating a transfer) is required, less time is required for the gate crew to analyze the SHM data and information. Of course, the removable memory device (or another portion of the ground-based SHM network) may be employed to reconfigure the SHM network 110A. Yet another embodiment provides a wireless interface to the SHM network 110A so that users may efficiently and securely access SHM data and information, and maintain software and data tables, accessible via the SHM system 110A.

In view of the foregoing, it will be seen that the several advantages of the invention are achieved and attained. The SHM architectures, systems, networks, and methods provided by the present invention reduce the time required for scheduled and unscheduled inspections. The present invention also ensures that inspections occur at optimal times while reducing the extent of repairs. Further, by placing the SHM related functions in a separate processor, network, or system, the present invention provides for a large degree of flexibility in expanding, modifying, and adapting the SHM functions for a particular mobile platform. For instance, a particular mobile platform operator (e.g. an airline) may specify different SHM functionality over that otherwise offered without impacting the flight worthiness of the other onboard systems. Nor would tailoring a mobile platform to specific desires consume resources that other systems would have to compete for. Thus, the present invention provides an open SHM architecture that is unencumbered by many of the restraints imposed on the other onboard systems. The embodiments were chosen and described in order to best explain the principles of the invention and its practical application to thereby enable others skilled in the art to best utilize the invention in various embodiments and with various modifications as are suited to the particular use comptemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A mobile platform comprising:
at least one mobile platform system including a processor;
a mobile platform structure; and
a structural health management (SHM) system including:
a SHM processor in communication with the mobile platform system and separate from the mobile platform system processor, and
at least one sensor in communication with the SHM processor and configured to sense a condition of the mobile platform structure.

2. The mobile platform according to claim 1, the at least one mobile platform system further comprising a flight control system configured to sense flight parameters.

3. The mobile platform according to claim 2, wherein the SHM processor is configured to receive the flight parameters from the flight control system and to calculate a load on the mobile platform structure therefrom.

4. The mobile platform according to claim 2, further comprising a load sensor sensing a load on a portion of the structure, the SHM processor further configured to communicate with the load sensor and to calculate a load on another portion of the structure from the load on the portion of the structure and the flight parameters.

5. The mobile platform according to claim 1, wherein the mobile platform is an aircraft.

6. The mobile platform according to claim 1, the mobile platform system further comprising a maintenance information system in communication with the SHM system and to receive information from the SHM system.

7. The mobile platform according to claim 1, further comprising an area exposed to impact and the at least one SHM sensor including an impact sensor positioned near enough to the impact exposed area to sense impacts.

8. The mobile platform according to claim 7, the area further comprising at least one of a cargo bay door, a passenger door, a service door, or a galley.

9. The mobile platform according to claim 1, the at least one mobile platform system further comprising an integrated mobile platform health monitoring system, the SHM system separate from and in communication with the integrated mobile platform health monitoring system.

10. The mobile platform according to claim 1, wherein the at least one mobile platform system has an availability requirement associated therewith which is higher than an availability requirement associated with the SHM system.

11. The mobile platform according to claim 1, wherein the SHM processor further comprises at least one of an algorithm, a neural network, or a look up table.

12. The mobile platform according to claim 1, further comprising a battery to power the SHM system.

13. The mobile platform according to claim 1, further comprising an SHM sensor sampled by a ground portion of the SHM system.

14. The mobile platform according to claim 1, wherein the SHM system is a distributed system.

15. The mobile platform according to claim 1, wherein the sensor is located in a position where access thereto requires removal of at least one of a mobile platform component or mobile platform structural element.

16. The mobile platform according to claim 1, wherein the sensor to be a damage sensor to detect damage to the structure.

17. The mobile platform according to claim 1, wherein the sensor to sense a condition related to corrosion.

18. The mobile platform according to claim 1, further comprising a dedicated SHM sensor the dedicated SHM sensor communicating with the SHM processor via the other mobile platform system.

19. The mobile platform according to claim 1, wherein the at least one sensor is located at approximately at least one location selected from the group consisting of a lavatory, a galley, a floor beam, a door, a pressure bulkhead, a fuselage, a wing hard landing inspection area, a vertical stabilizer attachment, a pylon to wing attachment, a strut, a fuselage crown structure, a fuselage structure under wing to body fairing, a wing rib, a cockpit window sill, a wing center section, a fuselage structure above the wing center section, a main landing gear bay, and a fuselage structure in the bilge area.

20. A method of monitoring the health of a mobile platform including a structure and at least one mobile platform system including a processor, the method comprising:
separating system health management (SHM) functions from the processor of the at least one mobile platform system;
dedicating an SHM system that includes an SHM processor to perform the SHM functions, whereby the separate SHM processor enables an open architecture for the SHM processor; and
establishing communications between the SHM system and the at least one mobile platform system.

21. The method according to claim 20, further comprising accepting a flight parameter from the at least one mobile platform system.

22. The method according to claim 21, further comprising calculating a load on the mobile platform structure with the SHM processor using the flight parameters.

23. The method according to claim 20, further comprising sensing a load on a portion of the mobile platform structure, accepting the flight parameter, and calculating a load on another portion of the mobile platform structure using the flight parameter and the sensed load.

24. The method according to claim 20, wherein the mobile platform is an aircraft.

25. The method according to claim 20, further comprising communicating data from the SHM system to a maintenance information system of the at least one mobile platform system.

26. The method according to claim 20, further comprising sensing an impact to an impact exposed area of the mobile platform.

27. The method according to claim 20, further comprising the sensing occurring near at least one of a cargo bay door, a passenger door, a service door, or a galley of the mobile platform.

28. The method according to claim 20, further comprising communicating between the SHM system and an integrated vehicle health management system of the at least one mobile platform systems.

29. The method according to claim 20, further comprising meeting an availability requirement associated with the at least one mobile platform system, meeting an availability requirement associated with the SHM system, the SHM system availability requirement being less stringent than the at least one mobile platform system availability requirement.

30. The method according to claim 20, further comprising using at least one of an algorithm, a neural network, or a look up table to perform an SHM function.

31. The method according to claim 20, further comprising powering the SHM system with a battery.

32. The method according to claim 20, further comprising sensing a condition related to corrosion.

33. The method according to claim 20, further comprising sensing an SHM related condition with a sensor and communicating the sensed condition to the SHM system via the at least one mobile platform system.

34. The mobile platform according to claim 20, further comprising placing an SHM sensor at approximately at least one location selected from the group consisting of a lavatory, a galley, a floor beam, a door, a pressure bulkhead, a fuselage, a wing hard landing inspection area, a vertical stabilizer attachment, a pylon to wing attachment, a strut, a fuselage crown structure, a fuselage structure under wing to body fairing, a wing rib, a cockpit window sill, a wing center section, a fuselage structure above the wing center section, a main landing gear bay, and a fuselage structure in the bilge area.

35. An aircraft comprising:
at least one aircraft system including a processor, the at least one system including an integrated vehicle health management system and a flight control system sensing a flight parameter;
a structure;
a structural health management (SHM) system including:
a SHM processor separate from the at least one aircraft system processor, in communication with the flight control system to calculate a load from the flight parameter, including a neural network, and located on the ground;
at least one sensor, the at least one sensor in communication with the SHM processor and configured to sense a condition of the aircraft structure, the at least one sensor including an impact sensor positioned near an impact exposed area of the aircraft structure to sense impacts, the SHM processor to locate the impact; and
a battery to power the SHM system.

36. A system for a fleet of mobile platforms, comprising:
at least one mobile platform including
at least one mobile platform system including a processor,
a mobile platform structure, and
a mobile platform based structural health management (SHM) system including:
a SHM processor in communication with the mobile platform system and separate from the mobile platform system processor, and
at least one sensor in communication with the SHM processor and configured to sense a condition of the mobile platform structure; and
a ground based SHM system in communication with the mobile platform SHM system.
